(19) United States
(12) Patent Application Publication
(10) Pub. No.: US 2023/0280458 A1
(43) Pub. Date: Sep. 7, 2023

(54) MMWAVE SENSING FOR CABLE IDENTIFICATION

(71) Applicant: CommScope Technologies LLC, Hickory, NC (US)

(72) Inventors: Matthew R. Kiener, Richardson, TX (US); Ryan E. Enge, Carrollton, TX (US)

(73) Assignee: CommScope Technologies LLC, Hickory, NC (US)

(21) Appl. No.: 18/005,825

(22) PCT Filed: May 25, 2021
(86) PCT No.: PCT/US21/33980

§ 371 Date: Jan. 17, 2023

Related U.S. Application Data
(60) Provisional application No. 63/053,411, filed on Jul. 17, 2020.

(51) Int. Cl. G01S 13/88; G01S 7/41; G06K 19/067; H01B 7/36

(52) U.S. Cl. CPC G01S 13/888; G01S 7/415; G06K 19/067; H01B 7/36

(57) ABSTRACT

A sensing system for identification of at least one cable is provided. The sensing system includes a transceiver and a controller. The transceiver is configured to transmit mmWave signals and receive reflected mmWave signals. The controller is in communication with the transceiver. The controller is configured to direct the transceiver to transmit the mmWave signals. The controller is further configured to process the reflected mmWave signals and identify highly reflective-to-mmWave material identification markings associated with the at least one cable from the processed reflected mmWave signals.

### CROSS-REFERENCE TO RELATED APPLICATIONS

This Application claims priority to U.S. Provisional Application Ser. No. 63/053,411, same title herewith, filed on Jul. 17, 2020, which is incorporated in its entirety herein by reference.

### BACKGROUND

Cabling, such as but not limited to, fiber optical cabling and copper wire cabling is used to provide services to a location. The cabling provides communication and power paths between devices. Examples of provided services include telecommunication systems and computer network services. Businesses typically have dedicated telecommunication systems that enable computers, telephones, facsimile machines and the like to communicate with each other, through a private network, and with remote locations via a telecommunications service provider. In most buildings, the dedicated telecommunications system is hard wired. In such hard wired systems, dedicated cabling is coupled to individual service ports throughout the building. The cables from the dedicated service ports extend through the walls of the building to a telecommunications closet or closets. The telecommunications lines from the interface hub of a main frame computer and the telecommunication lines from external telecommunication service providers may also terminate within a telecommunications closet.

In office/LAN environments, as employees move, change positions, and/or add and subtract lines, the patch cords in a typical telecommunications closet may be rearranged quite often. Further communication closets may be relocated or added as service needs change. As a result, cables that are concealed behind walls, ceilings and floors may need to be located when services are to be added or relocated. Concealed cable locations may also need to be located for maintenance reasons. However, it may take a significant amount of time for a technician to locate and identify a desired cable behind a wall or ceiling tile, etc. Accordingly, a need exists for accurately and quickly detecting and identifying the specific cables that are obstructed from view.

### SUMMARY

The following summary is made by way of example and not by way of limitation. It is merely provided to aid the reader in understanding some of the aspects of the subject matter described. Embodiments provide a mmWave sensing system configured to detect highly reflective-to-mmWave material identification markings associated with one or more cables through a non-metallic material obstruction to identify the cable(s) as well as a location of the identified cable(s).

In one embodiment, a sensing system for identification of at least one cable is provided. The sensing system includes a transceiver and a controller. The transceiver is configured to transmit mmWave signals and receive reflected mmWave signals. The controller is in communication with the transceiver. The controller is configured to direct the transceiver to transmit the mmWave signals. The controller is further configured to process the reflected mmWave signals and identify highly reflective-to-mmWave material identification markings associated with the at least one cable from the processed reflected mmWave signals.

In another example embodiment, another cable identification system is provided. The system includes highly reflective-to-mmWave material identification markings that are attached to at least one cable. The identification markings being configured to reflect mmWave signals. The metallic identification markers are further configured to convey a pattern read by a sensor system processing the reflected mmWave signals.

In yet another embodiment, a method of locating and identifying at least one cable, the method includes applying mmWave signals of select frequency to a location anticipated as containing the at least one cable; processing reflected mmWave signals to discover if identification markers are present in the processed reflected mmWave signals; comparing discovered identification markers with known identification markers; and generating cable information associated with matched discovered and known identification markers.

### BRIEF DESCRIPTION OF THE DRAWINGS

Embodiments can be more easily understood and further advantages and uses thereof will be more readily apparent, when considered in view of the detailed description and the following figures in which:

FIG. 1 illustrates a block diagram of a sensing system according to one exemplary embodiment.

FIG. 2 illustrates a cable with identification markings according to one exemplary embodiment.

FIG. 3 illustrates a cable bunch with identification markings according to one exemplary embodiment.

FIG. 4 illustrates a cable with identification markings according to yet another exemplary embodiment.

FIG. 5A illustrates a cable with identification markings according to another exemplary embodiment.

FIG. 5B illustrates an image representing the cable with identification markings of FIG. 5A.

FIG. 6 illustrates a sensor system flow diagram according to one exemplary embodiment.

In accordance with common practice, the various described features are not drawn to scale but are drawn to emphasize specific features relevant to the subject matter described. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the embodiments, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments use a millimeter wave (mmWave) sensing system that includes an ultra-wide bandwidth radar to penetrate solid objects such as drywall, brick and the earth. Although, mmWave signals pass through such objects, mmWave signals of select frequencies bounce off of highly reflective-to-mmWave material such as metallic material. For example, mmWave signals having a frequency around 60 giga Hz reflects off metal. Other the frequencies that cause mmWave signals to reflect of metallic objects while also penetrating non-metallic objects may also be used as well.

Using a radar system with mmWave signals that reflect off of metals, identification markings made of metal that are associated with cabling, can be identified behind the solid objects. Embodiments use various sized and spaced highly reflective-to-mmWave material identification markings such as bands that are unique to a specific cable. Embodiments may create a coding system that not only allows the cables to be located but also to be identified. Besides an identification of the cable, other identification information associated with the identification markings may be provided upon the detection of identification markings. The other identification information may include such information as cable type, location of cable, cable use, cable connections etc. Further, the identification markers may be part of global system that uses the same identification markers for the same type of cables. Further the identification markers may be locally unique to a specific cable. Although the sensing system described herein is directed to sensing identification markings associated with cabling, the identification markings may be used to identify other types of equipment and objects hidden from view.

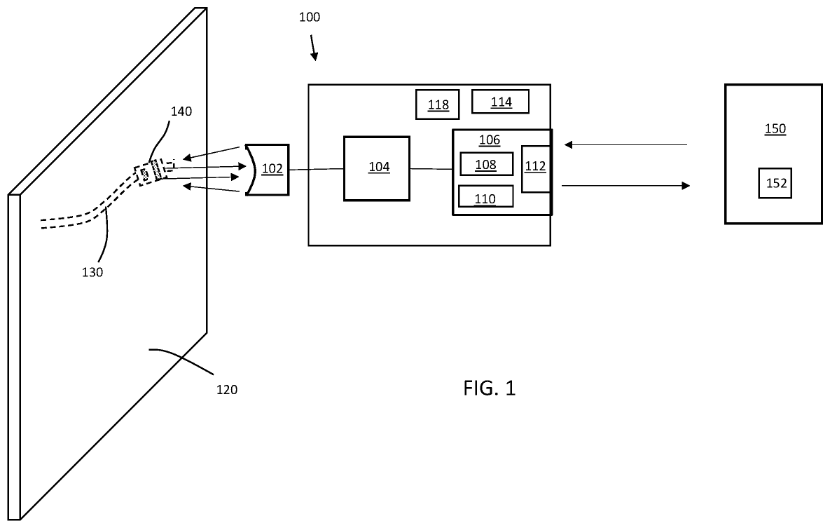

FIG. 1 illustrates a block diagram of a sensing system 100 of one example embodiment. The sensing system 100 includes an antenna 102 to radiate mmWave signals and detect reflected mmWave signals. A transceiver 104 is in communication with the antenna 102 to transmit the mmWave signals and receive the reflected mmWave signals. In another embodiment, a separate transmitter, receiver, transmission antenna and receiving antenna configuration may be used.

Transceiver 104 is in communication with a control system 106 in the example embodiment of FIG. 1. The control system 106 in this example includes a controller 108 and a memory 110. Further in an embodiment, the control system 106 may include a communication system 112, such as by not limited to, a cellular communication system that is configured to communicate with a remote base 150 that includes a remote database 152.

In general, the controller 108 may include any one or more of a processor, microprocessor, a digital signal processor (DSP), an application specific integrated circuit (ASIC), a field program gate array (FPGA), or equivalent discrete or integrated logic circuitry. In some example embodiments, controller 108 may include multiple components, such as any combination of one or more microprocessors, one or more controllers, one or more DSPs, one or more ASICs, one or more FPGAs, as well as other discrete or integrated logic circuitry. The functions attributed to the controller herein may be embodied as software, firmware, hardware or any combination thereof. The controller 108 may be part of a system controller or a component controller. The memory 110 may include computer-readable operating instructions that, when executed by the controller 108 provides functions of the sensing system 100. Such functions may include the functions of processing reflected mmWave signals described below. The computer readable instructions may be encoded within the memory 110. Memory 110 is an appropriate non-transitory storage medium or media including any volatile, nonvolatile, magnetic, optical, or electrical media, such as, but not limited to, a random access memory (RAM), read-only memory (ROM), non-volatile RAM (NVRAM), electrically-erasable programmable ROM (EEPROM), flash memory, or any other storage medium.

As illustrated in FIG. 1, the antenna 102 of the sensing system is directed towards an area in which it is desired to locate a concealed cable 130. In this example, the cable 130 is behind a wall 120. However, the cable 130 could be concealed in any location including a ceiling, a floor or even be buried in the ground. As directed by the controller 108, the transceiver 104 transmits the mmWave signals through the antenna 102. The signals pass through the wall 120 to the cable 130. The mmWave signals reflect off of the highly reflective-to-mmWave material identification markings 140 back to the antenna 102. The transceiver 104 communicates the reflected signals to the controller 108. The controller 108 processes the signals.

In one embodiment, the controller 108 decodes encoded patterns in the identification markings 140 into machine-usable decoded identification data that the controller 108 compares to identification data stored in the memory 110. If a match is found, identification information associated with the decoded identification data is generated. The generated identification information may be displayed on a display 114 and/or sent to the remote base 150. The generated identification information may also be stored locally in memory 110 or in a remote database. Further in an embodiment, the decoding and identification may take place at the remote base 150 with the generated identification information being sent back to the controller 108 when a match is found. Further in another embodiment, an image of the identification markings is compared with images in a database to generate the identification information.

In one embodiment, the sensing system 100 includes a location determining device 118. Examples of location determining devices include a global positioning satellite (GPS) device and indoor positioning system (IPS) device. An example of an IPS is a WiFi system that determines distances to nearby anchor nodes. The location determination device 118 may be used to provide location directions to a technician to where a cable is supposed to be located behind an object. The directions may be display on a display 114 of the sensing system. Further location information can also be used once a cable is detected with the sensing system 100 to store or update the location of the detected identification markings associated with the cable for future use either locally in memory 110 or in database 152 of the remote base 150.

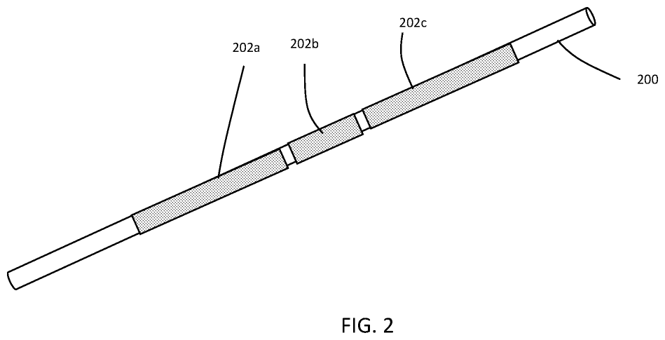

FIG. 2 illustrates a cable 200 with an example of highly reflective-to-mmWave material identification markings 202a, 202b, 202c. In this example, the three identification markings 202a, 202b and 202c identify the cable 200. The identification information associated with the identification markings 202a, 202b and 202c may be stored in the respective memory 110 or database 152. This identification information is retrieved from the memory 110 or database 152 when the identification markings 202a, 202b and 202c are identified. In one example, the three identification markings 202a, 202b and 202c may be directly deposited on or adhered to a plastic jacket of the cable or may be deposited or adhered on a label that is affixed to cable 200.

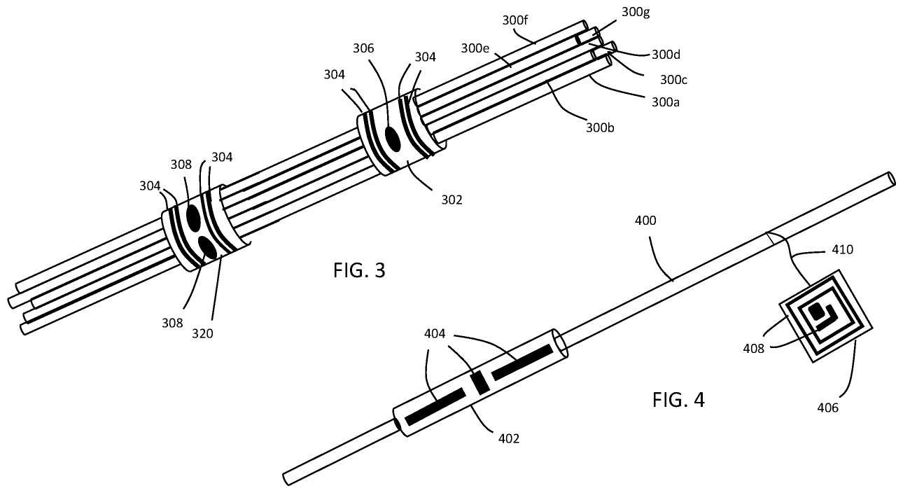

An example using labels for the identification markings is illustrated in FIG. 3. In particular, FIG. 3 illustrates an embodiment where a plurality of cables 300a through 300g are bundled together and are identified as belonging with the bundle with labels 302 and 320. The identification markings 304, 306 and 308 are adhered to the respective labels 302 and 320 which in turn are attached to the bundle of cables. As illustrated in this example, more than one set of identification markings may be used. Moreover, the identification markings in each set may be different along the length the cable or cable bundle. For example, label 302 includes a first set of identification markers 304 and 306 while label 320 includes a second set of identification markers 304 and 308. Having different identification markers along the length of a cable or cable bundle allows for the identification of a specific location along a length of the cable or cable bundle. This may be beneficial in situations where you are trying to identify the end of a concealed cable or cable bundle.

Further having identification markings spaced along a cable allows for a greater chance of locating a concealed cable. In addition, bundles of cables, such as cables 300a through 330g may include individual identification markers as long as the individual markers are spaced a select distance from each to allow the sensing system 100 to separate them out. The spaced select distance is based at least in part on the process resolution of the sensing system 100. Further as the mmWave technology and resolution techniques evolve, the size of the identification markers and the space between markers needed will decrease in size.

FIG. 4 illustrates further examples of identification markings associated with a cable 400. Labels 402 and 406 illustrates different patterns of highly reflective-to-mmWave material markings 404 and 408 that may be used. Further, label 406 illustrates that the markings need not be directly on an associated cable 400. In this example, label 406 with the identification markings is at a remote location from its associated cable 400. Further in this example, label 406 is tethered to the cable 400 via tether 410. In other embodiments the label need not be tethered. For example, if the cable 400 is positioned within the ground, the label 406 may simply be buried with the cable 400.

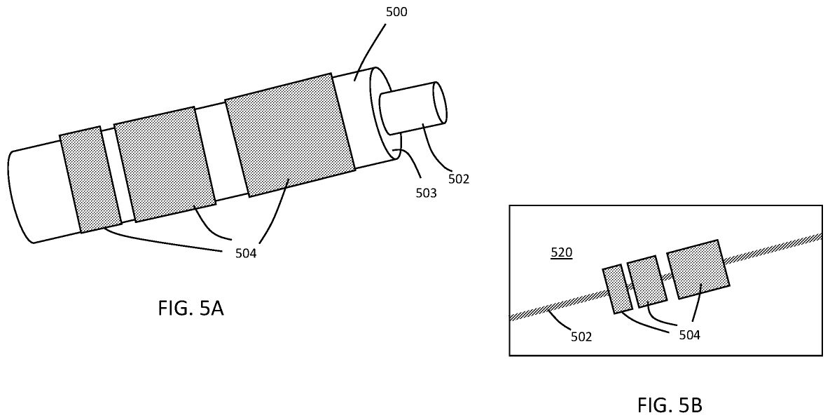

The identification system works well for optic fiber cables but may be used on any type of cable. For example, cables with metallic features, such as copper wires and cables with metallic shielding may also use this type of identification system. Referring to FIG. 5A an example of a copper wire cable 500 is illustrated. Cable 500 is illustrated as including copper wire 502. The identification markings 504 are separated from the copper wire 502 via non-metallic protective covering 503. FIG. 5B illustrates an image 520 produced from reflected processed mmWave signals. Since, the copper wire 502 is also metallic, the mmWave signals reflect off of it as shown in the image 520. However, since the protective covering 503 spaces the identification markings 504 away from the copper wire 502, the identification markings 504 are able to be identified in the image 520. Further, the copper wire 502 appearing in the image can be used as part of the identification of the cable 500 with the identification markings. That is, part of the metal features of the cable may be used with an associated identification marking in identifying a cable.

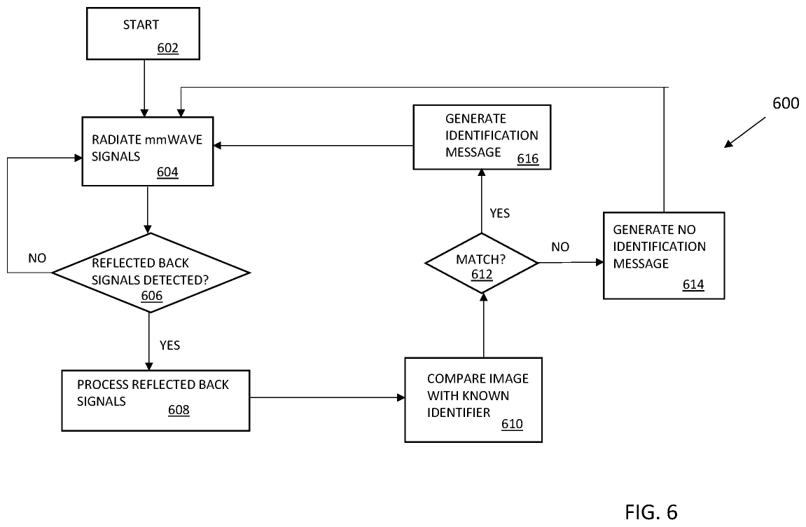

FIG. 6 illustrates a sensing system flow diagram 600 of one example embodiment. The flow diagram 600 is provided as a series of sequential blocks. The sequence, however, may be in a different order or be performed in a parallel fashion with other blocks in other embodiments. Hence, embodiments are not limited to the specific sequence of blocks set out in FIG. 6.

The process starts at block (602) by starting up the sensing system 100. The controller 108, based on instructions stored in the memory 110, direct the transceiver 104 to transmit mmWave signals of a select frequency that are radiated from the antenna 102 at block (604). A technician directs the antenna 102 in a direction of a wall, ceiling, floor, ground etc. the technician hopes to find a concealed cable behind or within.

The controller 108 monitors the transceiver 104 to determine if any mmWave signals have been reflected back through the antenna 102 at block (606). If no reflections are detected at block (606), the process continues at block (604) with the antenna radiating the mmWave signals. As the technician moves the direction of the antenna 102 along the wall, ceiling, floor, ground etc., any metal behind the wall, ceiling, floor, ground etc., will reflect the mmWaves back to the antenna 102. If the controller detects reflected mmWave signals at block (606) at the transceiver 104, the controller 108 processes the reflected mmWave signals at block (608) based on instructions stored in memory 110.

In one embodiment, processing the reflected mmWave signals comprise processing the reflected mmWave signals into images. The images are compared with known identifier images at block (610). In an embodiment, the know identification markers and associated identification information are stored in a database in the memory 110. In other embodiments, as discussed above, the identification information may be stored at a remote base 150 that is in communication with the controller 108. In one example embodiment, the comparing is done on a bit by bit level. Further, in embodiments, known processing techniques may be used to further define features in the reflected mmWave signals.

It is determined in block (612) if a match has been found. If no match is found, a “no identification message” is generated at bock (614) that may be displayed on display 114 of the sensing system 100. The process then continues at block (604) with the antenna radiating the mmWave signals.

If a match is detected at block (612), an “identification message” is generated at block (616). In an embodiment, the identification message is displayed on display 114 of the sensing system 100. As discussed above the identification message may include the type of cable, connection information, location of connection information, location of cable etc. In one embodiment, the identification information is communicated to the remote base 150 to be stored in the database 152.

### Example Embodiments

Example 1 includes a sensing system for identification of at least one cable. The sensing system includes a transceiver and a controller. The transceiver is configured to transmit mmWave signals and receive reflected mmWave signals. The controller is in communication with the transceiver. The controller is configured to direct the transceiver to transmit the mmWave signals. The controller is further configured to process the reflected mmWave signals and identify highly reflective-to-mmWave material identification markings associated with the at least one cable from the processed reflected mmWave signals.

Example 2 includes the sensing system of Example 1, further including an antenna and a memory. The antenna is configured to radiate the mmWave signals and detect the reflected mmWave signals. The memory is configured to store at least operating instructions. The controller is configured to direct the transceiver to transmit the mmWave signals, process the reflected mmWave signals and identify the identification markings from the processed reflected mmWave signals based on the stored operating instructions in the memory.

Example 3 includes the sensing system of any of the Examples 1-2, further including a communication system that is configured to communicate with a remote base.

Example 4 includes the sensing system of any of the Examples 1-3, wherein the controller is configured to process the reflected mmWave signals to decode identification data and compare the decoded identification data with identification data in a database.

Example 5 includes the sensing system of Example 4, wherein the database is remote from the sensing system.

Example 6 includes the sensing system of any of the Examples 1-5, wherein the controller is configured to determine a location of the at least one cable along a length of the at least one cable based on the identified identification markings.

Example 7 includes the sensing system of any of the examples 1-6, further including a position determining device that is configured to determine the location of the sensing system. The controller further configured to at least one of generate directions to where the at least one cable is believed to be located and store the location of the at least one cable once identified by the identification markings.

Example 8 includes a cable identification system. The system includes highly reflective-to-mmWave material identification markings that are attached to at least one cable. The identification markings being configured to reflect mmWave signals. The identification markers are further configured to convey a pattern read by a sensor system processing the reflected mmWave signals.

Example 9 includes the cable identification system of Example 8, wherein the identification markers are one of attached to a jacket of the at least one cable, attached to a label that is attached to a jacket of the at least one cable and tethered to the at least one cable.

Example 10 includes the cable identification system of any of the Examples 8-9, wherein the identification markings include a plurality of sets of identification markings that are spaced along a length of the at least one cable.

Example 11 includes the cable identification system of Example 10, wherein at least one set of the identification markings is different than at least one other set of the identification markings.

Example 12 includes the cable identification system of Example 11, wherein each set of the plurality of sets of the identification markers indicates a specific location along a length of the at least one cable.

Example 13 includes the cable identification system of Example 8, wherein the at least one cable includes a bundle of cables and the identification markings are used to identify at least one of the bundle of cables and at least one of the cables in the bundle of cables.

Example 14 includes a method of locating and identifying at least one cable, the method includes applying mmWave signals of select frequency to a location anticipated as containing the at least one cable; processing reflected mmWave signals to discover if identification markers are present in the processed reflected mmWave signals; identifying discovered identification markers; and generating cable information associated with matched discovered and known identification markers.

Example 15 includes the method of Example 14, wherein the generated cable information includes at least one of cable identification information, cable type information, location along a length of the cable information, cable use information and cable connections information.

Example 16 includes the method of any of the Examples 14-15, further wherein the processing of the reflected mmWave signals includes decoding the identification markers into identification data and comparing the decoded identification data with identification data in a database.

Example 17, includes the method of any of the Examples 14-16, further including displaying the generated cable information.

Example 18 includes the method of any of the Examples 14-17, further including directing a technician to a location where the at least one cable may be located using a location determining device.

Example 19 includes the method of any of the Examples 14-18, further including communicating at least one of cable identification information and location information to a remote base.

Example 20 includes the method of any of the Examples 14-19, wherein at least one of the processing reflected mmWave signals and comparing discovered identification markers with known identification markers is done at a remote location from a signal generator that generates the mmWave signals.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A sensing system for identification of at least one cable, the sensing system comprising:
a transceiver configured to transmit mmWave signals and receive reflected mmWave signals; and
a controller in communication with the transceiver, the controller configured to direct the transceiver to transmit the mmWave signals, the controller further configured to process the reflected mmWave signals and identify highly reflective-to-mmWave material identification markings associated with the at least one cable from the processed reflected mmWave signals.

2. The sensing system of claim 1, further comprising:
an antenna configured to radiate the mmWave signals and detect the reflected mmWave signals; and
a memory configured to store at least operating instructions, the controller configured to direct the transceiver to transmit the mmWave signals, process the reflected mmWave signals and identify the identification markings from the processed reflected mmWave signals based on the stored operating instructions in the memory.

3. The sensing system of claim 1, further comprising:
a communication system configured to communicate with a remote base.

4. The sensing system of claim 1, wherein the controller is configured to process the reflected mmWave signals to decode identification data and compare the decoded identification data with identification data in a database.

5. The sensing system of claim 4, wherein the database is remote from the sensing system.

6. The sensing system of claim 1, wherein the controller is configured to determine a location of the at least one cable along a length of the at least one cable based on the identified identification markings.

7. The sensing system of claim 1, further comprising:
a position determining device configured to determine a location of the sensing system, the controller further configured to at least one of generate directions to where the at least one cable is believed to be located and store the location of the at least one cable once identified by the identification markings.

8. A cable identification system comprising:
highly reflective-to-mmWave material identification markings attached to at least one cable, the identification markings being configured to reflect mmWave signals, the identification markings configured to convey a pattern read by a sensor system processing the reflected mmWave signals.

9. The cable identification system of claim 8, wherein the identification markers are one of attached to a jacket of the at least one cable, attached to a label that is attached to a jacket of the at least one cable and tethered to the at least one cable.

10. The cable identification system of claim 8, wherein the identification markings include a plurality of sets of identification markings that are spaced along a length of the at least one cable.

11. The cable identification system of claim 10, wherein at least one set of the identification markings is different than at least one other set of the identification markings.

12. The cable identification system of claim 11, wherein each set of the plurality of sets of the identification markers indicates a specific location along a length of the at least one cable.

13. The cable identification system of claim 8, wherein the at least one cable includes a bundle of cables and the identification markings are used to identify at least one of the bundle of cables and at least one of the cables in the bundle of cables.

14. A method of locating and identifying at least one cable, the method comprising:
applying mmWave signals of select frequency to a location anticipated as containing the at least one cable;
processing reflected mmWave signals to discover if identification markers are present in the processed reflected mmWave signals;
identifying the identification markers; and
generating cable information associated with matched discovered and known identification markers.

15. The method of claim 14, wherein the generated cable information includes at least one of cable identification information, cable type information, location along a length of cable information, cable use information and cable connections information.

16. The method of claim 14, further wherein the processing of the reflected mmWave signals includes decoding the identification markers into identification data and comparing the decoded identification data with identification data in a database.

17. The method of claim 14, further comprising:
displaying the generated cable information.

18. The method of claim 14, further comprising:
directing a technician to a location where the at least one cable may be located using a location determining device.

19. The method of claim 14, further comprising:
communicating at least one of cable identification information and location information to a remote base.

20. The method of claim 14, wherein at least one of the processing reflected mmWave signals and comparing discovered identification markers with known identification markers is done at a remote location from a signal generator that generates the mmWave signals.
